(19) United States
(12) Patent Application Publication
(10) Pub. No.: US 2012/0072003 A1
(43) Pub. Date: Mar. 22, 2012

(54) IMPRINTING METHOD, SEMICONDUCTOR INTEGRATED CIRCUIT MANUFACTURING METHOD AND DROP RECIPE CREATING METHOD

(76) Inventors: Yasuo MATSUOKA, Kanagawa (JP); Ryoichi Inanami, Kanagawa (JP); Akiko Mimotogi, Kanagawa (JP)

(21) Appl. No.: 13/208,638

(22) Filed: Aug. 12, 2011

(30) Foreign Application Priority Data
Sep. 22, 2010 (JP) 2010-212672

(51) Int. Cl. G06F 19/00

(52) U.S. Cl. 700/110

(57) ABSTRACT

According to one embodiment, a defect inspection is made on a pattern transferred on substrates to be processed, thereby generating defect image data. When a defect is detected, a defect contour is extracted from the generated image data, the extracted defect contour is reflected on a pattern of the semiconductor integrated circuit and a first drop recipe is generated based on the pattern data on which the defect contour is reflected. A drop recipe used for applying a hardening resin material is updated with the generated first drop recipe.

### CROSS-REFERENCE TO RELATED APPLICATIONS

This application is based upon and claims the benefit of priority from the prior Japanese Patent Application No. 2010-212672, filed on Sep. 22, 2010; the entire contents of which are incorporated herein by reference.

### FIELD

Embodiments described herein relate generally to an imprinting method, a semiconductor integrated circuit manufacturing method and a drop recipe creating method.

### BACKGROUND

A nanoimprint lithography technique (which will be simply referred to as nanoimprinting below) is known as a semiconductor integrated circuit manufacturing technique. The nanoimprinting is a technique for pressing a template on which a pattern of a semiconductor integrated circuit is formed onto a resist applied on a semiconductor wafer thereby to transfer the pattern formed on the template onto the resist. With the nanoimprinting, when a template is pressed onto a resist, a residual layer of the resist is at grooves of a resist pattern corresponding to convex parts of a template pattern. In order to reduce a difference in machining conversion in an etching step performed after the pressing step, it is necessary to reduce a positional variation in residual layer thickness in a die and a variation between the dies.

### BRIEF DESCRIPTION OF THE DRAWINGS

FIG. 1 is a diagram for explaining a transferring step by nanoimprinting;

FIG. 2 is a diagram for explaining an example in which a difference occurs between a template and a drop recipe;

FIG. 3 is a diagram for explaining an example in which a difference occurs between the template and the drop recipe;

FIG. 4 is a block diagram illustrating a structure of an imprinting system according to a first embodiment;

FIG. 5 is a diagram illustrating an exemplary template pattern;

FIG. 6 is a diagram for explaining a functional structure of a controller;

FIG. 7 is a diagram for explaining a modified defect contour shape;

FIG. 8 is a flowchart for explaining a semiconductor integrated circuit manufacturing method according to the first embodiment;

FIG. 9 is a flowchart for explaining a semiconductor integrated circuit manufacturing method according to a second embodiment;

FIG. 10 is a diagram for explaining a usage outline of a third embodiment;

FIG. 11 is a diagram for explaining a structure of a drop recipe creating system according to the third embodiment;

FIG. 12 is a diagram for explaining a functional structure of the controller; and

FIG. 13 is a flowchart for explaining the drop recipe creating method according to the third embodiment of the present invention.

### DETAILED DESCRIPTION

In general, according to one embodiment, a defect inspection is made on a pattern transferred onto a substrate to be processed, thereby generating defect image data. When a defect is detected, a defect contour is extracted from the generated image data and the extracted defect contour is reflected on pattern data of the semiconductor integrated circuit so that a first drop recipe is generated based on the pattern data on which the defect contour is reflected. Then a drop recipe used for applying a hardening resin material is updated by the generated first drop recipe.

Exemplary embodiments of an imprinting method, a semiconductor integrated circuit manufacturing method and a drop recipe creating method will be explained below in detail with reference to the accompanying drawings. The present invention is not limited to the following embodiments.

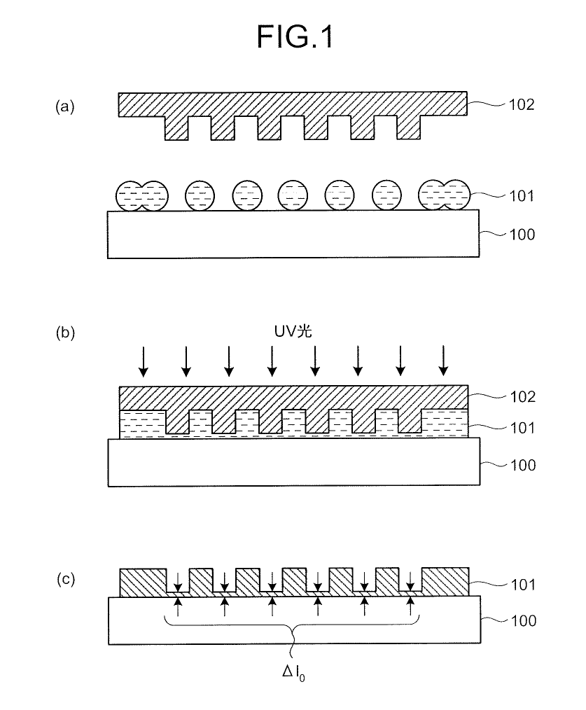

A typical transferring step by nanoimprinting will be first described. FIG. 1 is a diagram for explaining the transferring step by the nanoimprinting. Optical nanoimprinting for hardening a resist (optical hardening resin material) by ultraviolet light irradiation will be described herein by way of example, but the present embodiments are applicable to thermal nanoimprinting for hardening a resist (thermal hardening resin material) by heating.

In the transferring step, as illustrated in FIG. 1(a), a resist material 101 (exemplary hardening resin material) is first applied on a wafer 100 to be processed (exemplary substrate to be processed). An imprinting apparatus has a nozzle that is two-dimensionally driven in parallel to the wafer 100 and is directed for discharging the resist material 101, and may locally change the application amount of the resist material 101 based on a drop recipe defining an application amount distribution of the resist material. The drop recipe is created based on design data (pattern data) of a design pattern (or resist pattern or template pattern may be possible). The drop recipe is defined such that the application amount is large at a resist pattern with high density and the application amount is small at a resist pattern with low density. In FIG. 1(a), with the nanoimprinting apparatus of this type, droplets of the resist material 101 are dropped on concave parts of a template 102.

Subsequently, the template 102 is pressed onto the wafer 100 applied with the resist material 101. The resist material 101 enters the concave parts of the template pattern formed on the template 102 due to a capillary action. After the resist material 101 fully enters the template pattern, an ultraviolet light is irradiated from above the template 102 as illustrated in FIG. 1(b). The template 102 is made of a material such as quartz capable of transmitting an ultraviolet light, and the ultraviolet light irradiated from above the template 102 transmits the template 102 to be irradiated onto the resist material 101. The resist material 101 is hardened by the ultraviolet light irradiation.

After the resist material 101 is hardened, the template 102 is separated therefrom and the resist pattern is formed of the hardened resist material 101 on the wafer 100 as illustrated in FIG. 1(c). Although the grooves of the resist pattern are formed on the convex parts of the template 102, the pressing needs to be performed for a limited time and the wafer 100 needs to be prevented from breaking due to the pressing of the template 102 onto the wafer 100 so that a slight residual layer remains in the grooves of the resist pattern. When the drop recipe is appropriately set for the template 102, the residual layer thickness (RLT) is uniform over the wafer 100. In the example of FIG. 1, as illustrated in FIG. 1(a), the drop recipe is appropriately set and the residual layer thickness has a uniform value of □I0.

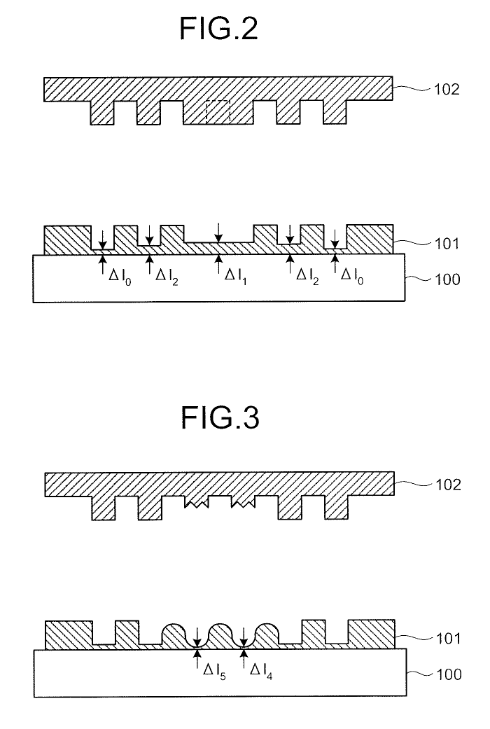

However, when a defect occurs on the template 102 while the template 102 is being used, and the template 102 is to be continuously used, a difference may occur between the template pattern and the drop recipe. There will be described below an example in which a difference occurs between the template 102 and the drop recipe with reference to FIGS. 2 and 3.

In FIG. 2, the concave part indicated by a dotted line in the template 102 is lost. The loss of the concave part is caused by the entrance of particles into the concave part, for example. Since when the template 102 is used, there is no enough time for the resist material 101 dropped on the concave part lost during the pressing to fully move to the surrounding concave parts, the residual layer thickness (DI1) at the positions corresponding to the convex parts adjacent to the lost concave part are thicker than the residual layer thickness at other positions. In the figure, the residual layer thickness is larger closer to the lost concave part (DI1>DI2>DI0).

In FIG. 3, part of the convex parts of the template 102 are lost. The loss of the convex parts occur due to a strong force on the template 102 when the template 102 is separated, for example. When the template 102 is used, the resist material 101 is locally lacking around the lost part and the resist material 101 does not fully enter the convex parts and the concave parts of the template pattern. Thus, the residual layer thickness at the grooves of the resist pattern corresponding to the lost convex parts does not reach the desired thickness. In the figure, the residual layer thicknesses (DI4, DI5) at the positions corresponding to the two lost convex parts are both smaller than DI0.

In this way, when a defect occurs on the template 102 during the transferring step, the residual layer thickness around the defect changes. The residual layer thickness changes before and after the occurrence of the defect. When the residual layer thickness changes, the rate of process in the etching step varies and consequently a reduction in yield is caused. According to the embodiments of the present invention, in order to reduce the change in residual layer thickness, the drop recipe is reset in consideration of influences of an occurred defect when the defect occurs.

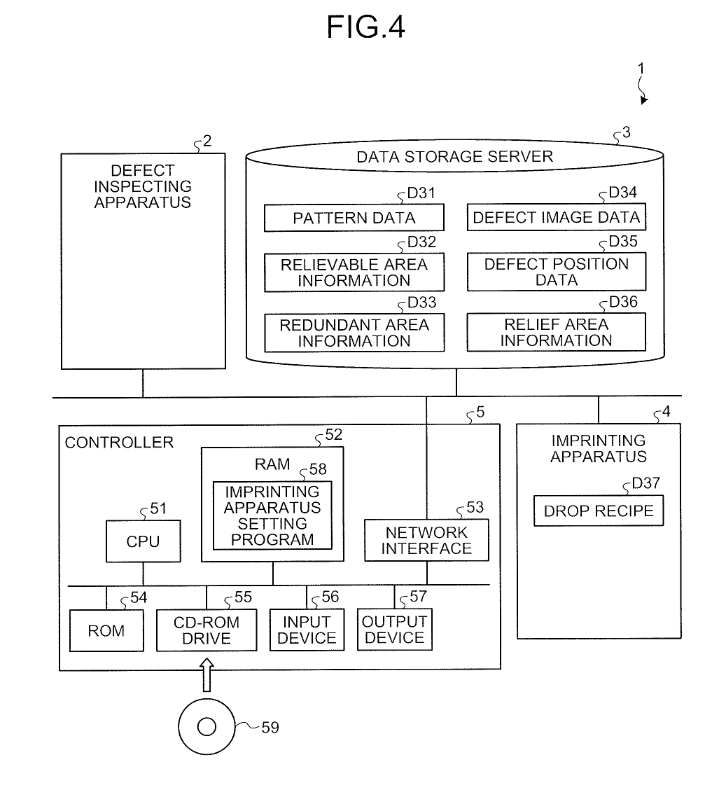

FIG. 4 is a block diagram illustrating a structure of an imprinting system according to a first embodiment of the present invention. As illustrated, the imprinting system 1 includes a defect inspecting apparatus 2, a data storage server 3, an imprinting apparatus 4 and a controller 5. The defect inspecting apparatus 2, the data storage server 3, the imprinting apparatus 4 and the controller 5 are interconnected via a network such as Internet or Intranet.

The imprinting apparatus 4 is installed to be incorporated in a semiconductor integrated circuit manufacturing line and sequentially performs the resist pattern transferring step on the wafers flowing on the manufacturing line. When applying the resist material on the wafer, the imprinting apparatus 4 controls an application amount distribution based on a drop recipe D37 set by the controller 5.

The defect inspecting apparatus 2 makes a defect inspection on the resist pattern formed on the wafer. Specifically, the defect inspecting apparatus 2 captures a SEM (Scanning Electron Microscope) image of the wafer onto which the template pattern is transferred, and outputs the captured SEM image (defect image data D34). The defect inspecting apparatus 2 creates defect position data D35 describing the position of a defect occurring on the template based on the defect image data D34. The defect image data D34 and the defect position data D35 are stored in the data storage server 3.

The defect position data D35 may be text data describing defect coordinates or data indicating the defect coordinates in a bitmap form, for example. The defect inspecting apparatus 2 may capture a microscopic-optical image not the SEM image and output the captured microscopic-optical image, and additionally may create the defect position data S35 based on the captured image.

The data storage server 3 stores therein various items of data used in the imprinting system 1. Specifically, the data storage server 3 stores therein pattern data D31 as the design data describing the design pattern of a semiconductor integrated circuit to be manufactured and information on a memory cell array (relievable area information D32 on positions of relievable areas and redundant area information D33 on positions of redundant areas). The data storage server 3 stores therein the defect image data 34, the defect position data D35 and the relief area information D36 created by the defect inspecting apparatus 2. Any format may be employed for the pattern data D31 and a CAD format such as GDS may be employed, for example. The pattern data D31 may employ the design data on resist pattern or template pattern.

In a memory cell array of a memory device formed on the substrate, when a failure occurs due to incidentally-occurred pattern disconnection or contact, a redundant circuit is typically applied for replacing the failure with a circuit. Thus, when a defect occurs in a memory cell array area replaceable with the redundant circuit, the memory cell array area can be relieved in a later step.

Specifically, a control circuit for controlling the operations of a memory chip controls the operations per unit (relievable area) in the memory cell array by addressing. When the addressing meets a condition under which a row or column including the failure is selected, the control circuit stops selecting and driving the address, and selects and drives an address corresponding to a row or column of a memory cell array (redundant area) as a redundant circuit provided in another position inside the memory cell array.

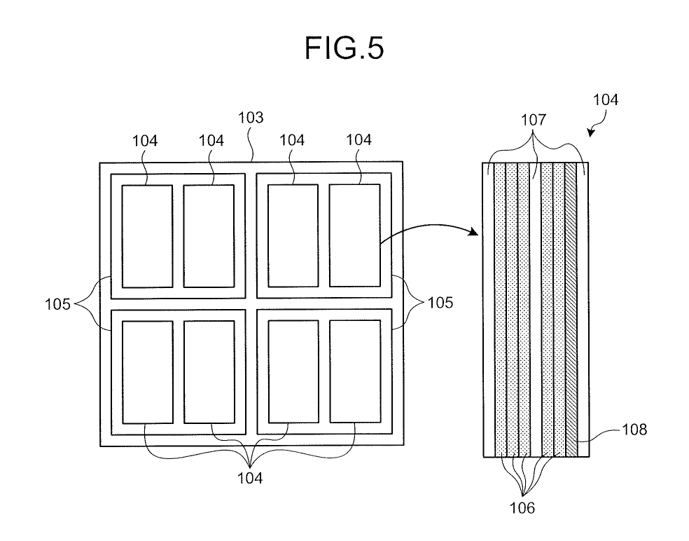

FIG. 5 is a diagram illustrating an exemplary template pattern. With a template pattern 103 in the example of FIG. 5, a pattern of memory chips 105 each having two memory cell arrays 104 is transferred by one pressing. The memory cell arrays 104 each include five relievable areas 106, three non-relievable areas 107 and a redundant area 108. The non-relievable area 107 corresponds to a peripheral circuit for accessing the memory cell array, such as row decoder or column decoder. When a defect is found in one of the five relievable areas 106, the defect-occurred relievable area 106 is replaced with the redundant area 108. The numbers of relievable areas 106 and redundant areas 108 illustrated in FIG. 5 are merely exemplary, and the memory cell array is increasingly highly integrated at present so that the memory cell array actually includes more relievable areas 106 and redundant areas 108 than those in the example of FIG. 5.

The relievable area information D32 indicates the positions of the relievable areas and the redundant area information D33 indicates the positions of the redundant areas. The relief area information D36, which is created by the controller 5, indicates the relievable areas set as relief areas. The relievable area information D32, the redundant area information D33 and the relief area information D36 may be data describing the range of relievable area and the range of redundant area in coordinates or may be data on the respective ranges in a bitmap form.

The controller 5 generates the drop recipe D37 based on the pattern data D31 stored in the data storage server 3, and sets the generated drop recipe D37 in the imprinting apparatus 4. When finding a new defect with reference to the defect position data D35, the controller 5 decides whether the found defect is relievable based on the relievable area information and the redundant area information. When deciding that the defect is relievable, the controller 5 regenerates the drop recipe D37 based on the defect image data D34 and the pattern data D31, and resets the regenerated drop recipe D37 in the imprinting apparatus 4. The structure of the controller 5 will be described below in more detail.

The controller 5 is configured similar to a typical computer to have a CPU (Central Processing Unit) 51, a RAM (Random Access Memory) 52, a network interface 53, a ROM (Read Only Memory) 54, a CD-ROM drive 55, an input device 56 and an output device 57. The CPU 51, the RAM 52, the network interface 53, the ROM 54, the CD-ROM drive 55, the input device 56 and the output device 57 are interconnected via a bus line.

The CPU 51 executes an imprinting apparatus setting program 58 as computer program for setting the drop recipe D37. The input device 56 includes a mouse and a keyboard, and is input the operations of the controller 5 by an operator. Operation information input into the input device 56 is sent to the CPU 51.

The imprinting apparatus setting program 58 is stored in the ROM 54 and is loaded to the RAM 52 via the bus line. The CPU 51 executes the imprinting apparatus setting program 58 loaded in the RAM 52. The CPU 51 executes the imprinting apparatus setting program 58 developed in the RAM 52 to create the drop recipe D37, and sets the created drop recipe D37 in the imprinting apparatus 4.

The output device 57 is a display device such as liquid crystal monitor, and displays output information such as operation screen for the operator based on the instructions from the CPU 51. The network interface 53 is a connection interface for connecting to a network to which the defect inspecting apparatus 2, the data storage server 3 and the imprinting apparatus 4 are connected. The CD-ROM drive 55 is a readout device for reading a CD-ROM 59 as a computer-readable recording medium.

The imprinting apparatus setting program 58 executed by the controller 5 may be stored on the computer connected to the network such as Internet and may be downloaded via the network to be provided or distributed. The imprinting apparatus setting program 58 may be provided or distributed via the network such as Internet. The imprinting apparatus setting program 58 may be previously incorporated in the ROM 54 or the like to be provided to the controller 5. The imprinting apparatus setting program 58 may be recorded in a recording medium such as the CD-ROM 59 to be provided or distributed. The imprinting apparatus setting program 58 recorded in the CD-ROM 59 is read by the CPU 51 via the CD-ROM drive 55 and is developed in the RAM 52.

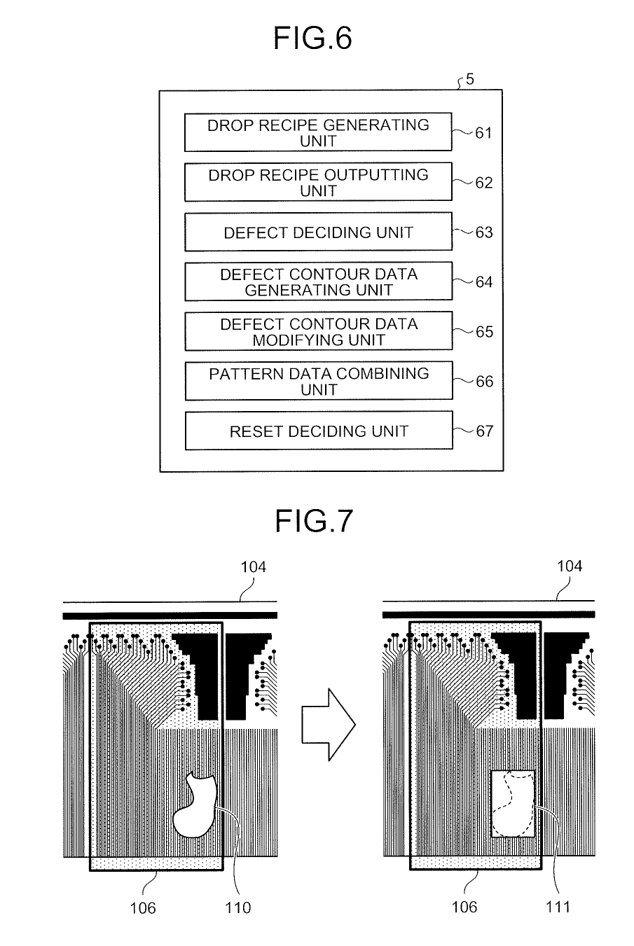

FIG. 6 is a diagram for explaining a functional structure of the controller 5 which is formed in the RAM 52 by the controller 5 executing the imprinting apparatus setting program 58. As illustrated, the controller 5 includes a drop recipe generating unit 61, a drop recipe outputting unit 62, a defect deciding unit 63, a defect contour data generating unit 64, a defect contour data modifying unit 65, a pattern data combining unit 66 and a reset deciding unit 67.

The drop recipe generating unit 61 generates a drop recipe based on the pattern data D31. The drop recipe D37 defines an application amount distribution such that the application amount is large at a resist pattern with high density and the application amount is small at a resist pattern with low density. The drop recipe generating unit 61 generates two modified drop recipes based on the two items of pattern data output by the pattern data combining unit 66. The modified drop recipes generated are temporarily stored in the RAM 52, for example.

The drop recipe outputting unit 62 sets the drop recipe D37 created by the drop recipe generating unit 61 in the imprinting apparatus 4.

The defect deciding unit 63 detects a defect with reference to the defect position data D35. When finding a new defect, the defect deciding unit 63 decides whether the defect is relievable based on the relievable area information D32 and the redundant area information D33. When deciding that the defect is relievable, the defect deciding unit 63 outputs the relief area information D36 indicating that the defect-occurred position is set as relief area.

The defect contour data generating unit 64 extracts a contour of the defect which is decided to be relievable from the defect image data D34, and creates defect contour data describing the contour shape of the defect. The defect contour data is temporarily stored in the RAM 52, for example. A format of the defect contour data may be the same as the pattern data D31.

The defect contour data modifying unit 65 modifies the defect contour shape described in the defect contour data into a rectangular shape including the defect. The modified defect contour data is also temporarily stored in the RAM 52. FIG. 7 is a diagram for explaining a modified defect contour shape. When a defect has an irregular shape illustrated by numeral 110 in the left of FIG. 7, the defect is modified to the rectangular shape illustrated by numeral 111 including the outermost periphery of the defect (indicated by the dotted line in the right of FIG. 7) therein as illustrated in the right of FIG. 7. The defect shape is modified to be rectangular so that the data size of the defect contour data can be reduced. The defect contour data modifying unit 65 may modify the defect contour into a rectangles-combined shape not one rectangle.

The pattern data combining unit 66 combines the defect contour data (before and after modification) and the pattern data D31 to create the pattern data. The two items of pattern data are sent to the drop recipe generating unit 61 via the RAM 52 so that the drop recipe generating unit 61 generates two modified drop recipes. The modified drop recipe which is generated based on the pattern data combining the defect contour data before modification and the pattern data D31 will be called a first modified drop recipe, and the modified drop recipe which is generated based on the pattern data combining the defect contour data after modification and the pattern data D31 will be called a second modified drop recipe. The drop recipe before modification will be a pre-modification drop recipe. Each modified drop recipe is temporarily stored in the RAM 52.

The reset deciding unit 67 decides whether to reset the drop recipe D37. Specifically, the reset deciding unit 67 finds RLT distributions based on the pre-modification drop recipe, the first modified drop recipe and the second modified drop recipe, respectively, and calculates differences between the pre- and post-modification RLTs. When either one of a difference between the RLT based on the pre-modification drop recipe and the RLT based the first drop recipe and a difference between the RLT based on the pre-modification drop recipe and the RLT based on the second drop recipe exceeds a preset permissible range, the reset deciding unit 67 sends the first modified drop recipe to the drop recipe outputting unit 62. The drop recipe outputting unit 62 sets the sent first modified drop recipe as the drop recipe D37 in the imprinting apparatus 4. Since the second drop recipe is generated by use of the modified defect contour data, the difference between the RLT based on pre-modification drop recipe and the RLT based on the second drop recipe has a larger value than the difference between the RLT based on the pre-modification drop recipe and the RLT based on the first drop recipe. Thus, the difference calculated based on the pre-modification drop recipe and the second drop recipe is used so that an acceleration test aspect is considered thereby to tighten the decision reference for the avoidance of reset. The positional range used for calculating the differences may be not only the entire pattern but also the surroundings of a newly-found defect.

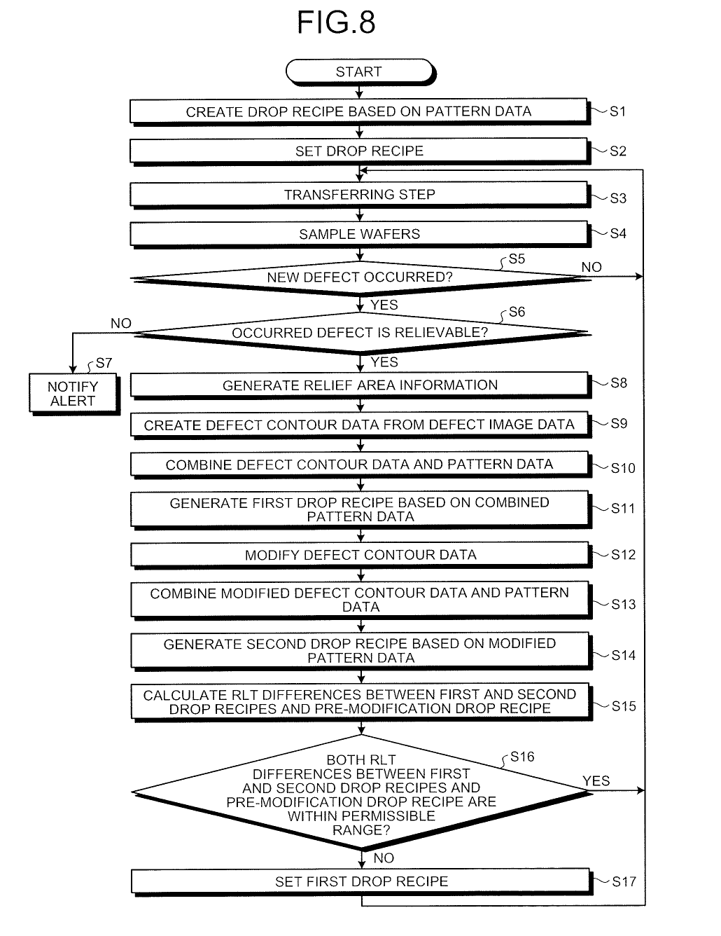

FIG. 8 is a flowchart for explaining a semiconductor integrated circuit manufacturing method according to the first embodiment of the present invention. As illustrated, the drop recipe generating unit 61 first generates the drop recipe D37 based on the pattern data D31 stored in the data storage server 3 (step S1). The drop recipe outputting unit 62 sets the generated drop recipe D37 in the imprinting apparatus 4 (step S2).

The imprinting apparatus 4 uses the set drop recipe D37 to perform the transferring step (step S3). The defect inspecting apparatus 2 samples the wafers and makes the defect inspection on the resist pattern generated in the transferring step (step S4). The defect inspecting apparatus 2 generates the defect image data D34 and the defect position data D35 and stores them in the data storage server 3. The defect inspecting apparatus 2 is configured to sample the wafers herein, but may be configured to sequentially inspect all the waters on which the resist pattern is formed.

The defect deciding unit 63 decides whether a new defect has occurred in the wafer based on the defect position data D35 (step S5). When the newly-output defect position data D35 is compared with the defect position data D35 at the previous defect inspection and a difference is present therebetween, it can be decided that a new defect has occurred. Alternatively, since a defect occurring in a relievable area is set as a relief area in step S8 described later, the relievable area in which the defect which is already found and decided as relievable is present is set as relief area. Thus, when a defect has occurred in an area other than the areas set as the relief area in the relief area information D36 among the defect-inspected areas, it can be decided that a new defect has occurred.

When a new defect has not occurred in the wafer (step S5, No), the processing proceeds to step S3. When a new defect has occurred (step S5, Yes), the defect deciding unit 63 refers to the relievable area information D32 and the redundant area information D33 to decide whether the defect is relievable (step S6). When the occurred defect is positioned within the relievable area, the defect can be relieved. When the occurred defect is not relievable (step S6, No), the defect deciding unit 63 outputs an alert on a display screen of the output device 57 (step S7). When the occurred defect is relievable (step S7, Yes), the defect deciding unit 63 generates the relief area information D36 for setting the relievable area including the defect-occurred position as an relief area (step S8). When the relief area information D36 has already been generated, the relievable area including the new defect-occurred position is added in the relief area information D36 and is edited as the relief area.

Subsequently, the defect contour data generating unit 64 creates the defect contour data from the defect image data D34 (step S9). The pattern data combining unit 66 combines the created defect contour data and the pattern data D31 (step S10). The drop recipe generating unit 61 creates the first drop recipe based on the combined pattern data (step S11).

The defect contour data modifying unit 65 modifies the defect contour shape described in the defect contour data into a rectangular shape (step S12). The pattern data combining unit 66 combines the modified defect contour data and the pattern data D31 (step S13). The drop recipe generating unit 61 creates the second drop recipe based on the pattern data combined in step S13 (step S14).

The reset deciding unit 67 calculates a difference RLT between the first drop recipe and the pre-modification drop recipe and a difference RLT between the second drop recipe and the pre-modification drop recipe (step S15). The pre-modification drop recipe is the drop recipe D37 which is being set in the imprinting apparatus 4 and is being used at that point.

After step S15, the reset deciding unit 67 decides whether both the calculated differences RLTs are within the permissible range (step S16). When both the differences RLT are within the permissible range (step S16, Yes), the processing proceeds to step S3. When either one of the two differences RLTs is out of the permissible range (step S16, No), the drop recipe outputting unit 62 sets the first drop recipe in the imprinting apparatus 4 (step S17) and proceeds to step S3.

As described above, according to the first embodiment, since there is configured such that the defect inspection is made on the pattern transferred on the wafer to generate the defect image data D34 (step S4), when a defect is detected (step S5, Yes, step S6, Yes), the defect contour (defect: contour data) is extracted from the defect image data D34 (step S9), the extracted defect contour is reflected on the pattern data D31 of the semiconductor integrated circuit to generate the first drop recipe based on the pattern data on which the defect contour is reflected (step S11) and the drop recipe D37 used in step S3 is updated with the generated first drop recipe (step S15, step S16 and step S17), the drop recipe D37 is updated to correspond to a defect-occurred template each time the defect occurs in the template so that the positional variation in residual layer thickness in the die and the variation in residual layer variation between the dies can be reduced.

As can be seen from FIGS. 2 and 3, as the occurred defect is larger in its size, the variation in RLT is larger. Since there is configured such that the RLTs are calculated based on the set drop recipe D37 and the first drop recipe, respectively (step S15) and a decision is made as to whether to update the set drop recipe D37 based on whether the difference between the calculated RLTs is within the permissible range (step S16), the drop recipe D37 can be flexibly updated depending on the influence of the occurred defect on the RLTs.

Since there is configured such that the defect contour is modified into a rectangular shape including the defect contour or a rectangles-combined shape (step S12), the modified defect contour is reflected on the pattern data D31 (step S13), the second drop recipe is generated based on the pattern data on which the modified defect contour is reflected (step S14), the RLTs are calculated based on the set drop recipe D37, the first drop recipe and the second drop recipe, respectively (step S15) and a decision is made as to whether to update the drop recipe D37 based on whether both the difference between the RLT of the set drop recipe D37 and the RLT of the first drop recipe and the difference between the RLT of the set drop recipe D37 and the RLT of the second drop recipe are within the permissible range (step S16), the condition not for updating the drop recipe D37 is tightened, thereby reasonably enhancing the frequency of updating the drop recipe D37.

When a relievable defect is found, the defect may be actually processed into the rectangular shape as indicated by numeral 111 in the right of FIG. 7. The rectangular shape may be employed in consideration of the minimum size of the droplet of the resist material capable of being discharged from the nozzle. For example, when the nozzle can discharge a droplet with diameter of 10 □m, each side may be as long as integral times of 10 mm. In this way, the drop recipe can be made more appropriate.

At the start of the imprinting by use of a new template, when the defect image data D34 and the defect position data D35 for the new template have been already obtained, the defect image data D34 and the defect position data D35 may be used to generate the drop recipe. The defect image data D34 and the defect position data D35 for the new template are supplied by a template manufacturer, for example.

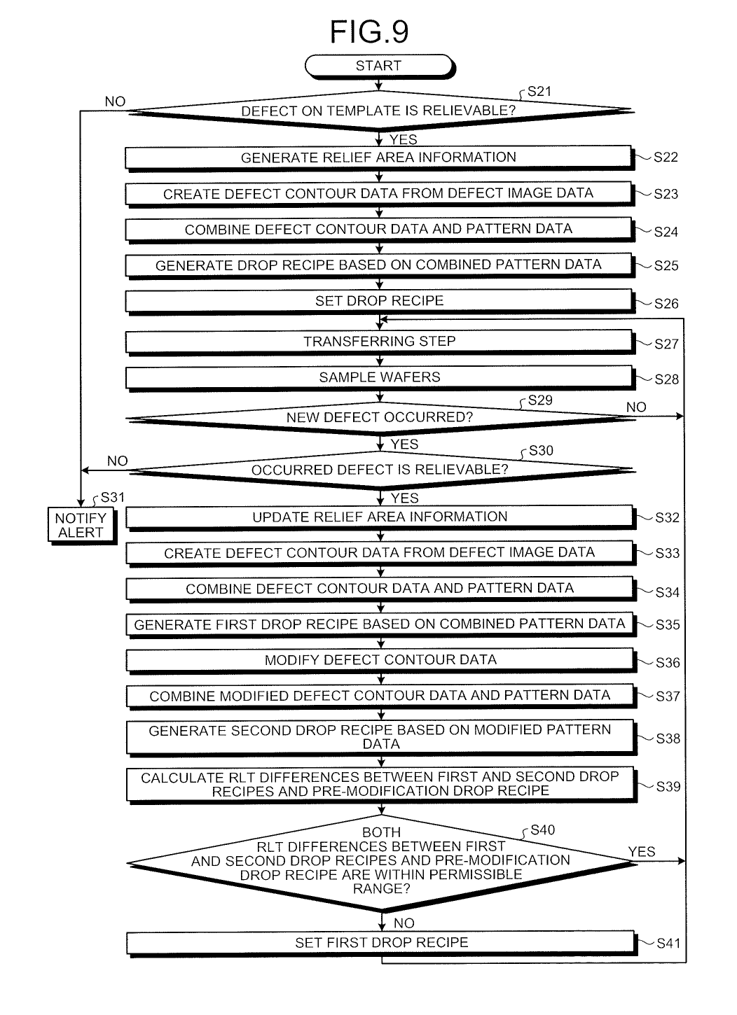

FIG. 9 is a flowchart for explaining a semiconductor integrated circuit manufacturing method according to a second embodiment of the present invention. The imprinting system for performing the semiconductor integrated circuit manufacturing method according to the second embodiment is the same as the first embodiment with the exception that the defect image data D34 and the defect position data D35 are previously stored in the data storage server 3, and an explanation thereof will be omitted.

As illustrated, the defect deciding unit 63 first refers to the defect position data D35, the relievable area information D32 and the redundant area information D33 previously stored in the data storage server 3 to decide whether the defect occurred in the new template is relievable (step S21). The deciding method in step S21 is the same as step S6 in the first embodiment.

When the defect is not relievable (step S21, No), the defect deciding unit 63 outputs an alert on the display screen of the output device 57 (step S31). When the occurred defect is relievable (step S21, Yes), the defect deciding unit 63 generates the relief area information D36 for setting the relievable area including the defect-occurred position as the relief area (step S22).

Subsequently, the defect contour data generating unit 64 creates the defect contour data from the defect image data D34 previously stored in the data storage server 3 (step S23). The pattern data combining unit 66 combines the created defect contour data and the pattern data D31 (step S24). The drop recipe generating unit 61 creates the drop recipe based on the combined pattern data (step S25). The drop recipe outputting unit 62 sets the generated drop recipe D37 in the imprinting apparatus 4 (step S26).

Thereafter, in step S27 to step S41, the processings similar to those in step S3 to step S17 according to the first embodiment are performed.

In this way, according to the second embodiment, since there is configured such that the defect contour (defect contour data) is extracted from the previously-prepared defect image data D34 of the defect on the template at the start of the application of the resist material (step S23), the extracted defect contour data is reflected on the pattern data D31 of the semiconductor integrated circuit (step S24), the drop recipe is generated based on the pattern data D31 on which the defect contour is reflected (step S25) and the generated drop recipe is set as the drop recipe D37 used for applying the resist material (step S26), the positional variation in residual layer thickness in the die immediately after the start of the transferring can be reduced when the imprinting is started by use of a new template.

There has been described above that the defect image data D34 and the defect position data D35 are previously prepared, but when the relief area information D36 corresponding to the defect occurring in the new template is also previously prepared, the processing may start from step S23 by skipping step S21 and step S22.

In the field of photolithography, when a defect is present in a manufactured photomask, a photomask manufacturer may modify the defect into a rectangular shape for delivery as indicated by numeral 111 in FIG. 7 in order to prevent a quality management from being complicated due to the defect on the photomask which may or may not appear on the resist pattern due to a variation in condition in the lithography step. Also for the manufacture of the templates, the template manufacturer may modify the defect on the template into a rectangular shape for delivery. In the second embodiment, even when the template in which the defect is modified into a rectangular shape is delivered, the transferring may be performed such that the residual layer thickness on the die is uniform.

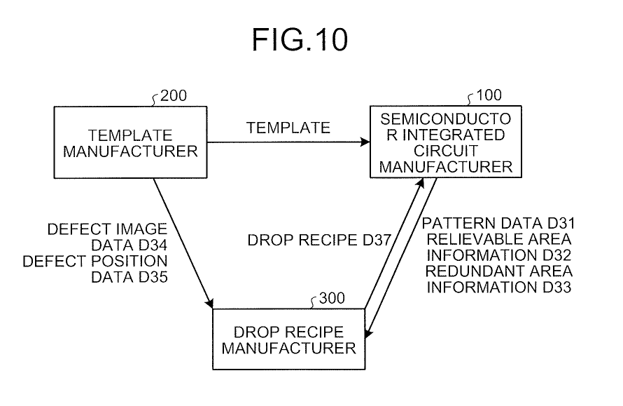

The semiconductor integrated circuit, the template and the drop recipe may be manufactured by different manufacturers, respectively. In a third embodiment, the drop recipe is created by a drop recipe manufacturer. FIG. 10 is a diagram for explaining a usage outline of the third embodiment.

As illustrated in FIG. 10, a template manufacturer 200 manufactures templates at the request of the semiconductor integrated circuit manufacturer 100, and delivers the manufactured templates to the semiconductor integrated circuit manufacturer 100. The template manufacturer 200 makes the defect inspection on the manufactured templates, generates the defect image data D34 and the defect position data D35, and transmits the generated data to a drop recipe manufacturer 300. The semiconductor integrated circuit manufacturer 100 previously transmits the pattern data D31 of the template, the relievable area information D32 and the redundant area information D33 to the drop recipe manufacturer 300.

The drop recipe manufacturer 300 creates the drop recipe D37 based on the pattern data D31, the relievable area information D32, the redundant area information D33, the defect image data D34 and the defect position data D35, which have been transmitted, and delivers the created drop recipe D37 to the semiconductor integrated circuit manufacturer 100. The semiconductor integrated circuit manufacturer 100 performs the transferring step by use of the templates sent from the template manufacturer 200 and the drop recipe sent from the drop recipe manufacturer 300.

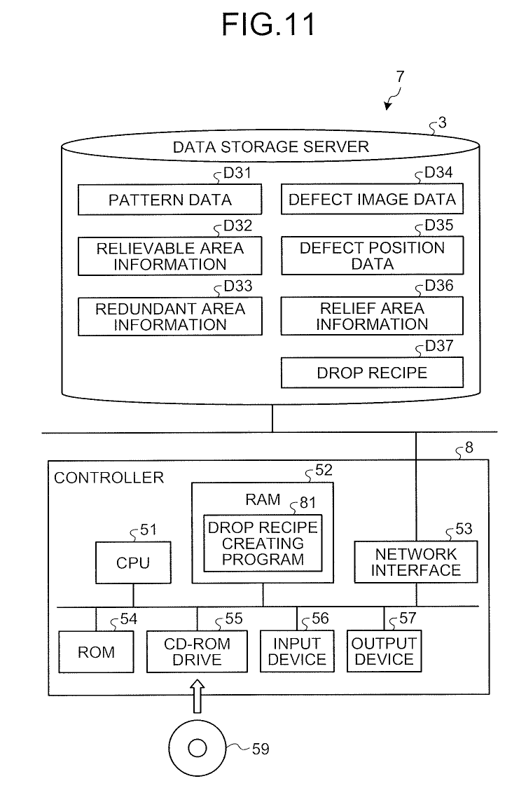

FIG. 11 is a diagram for explaining a structure of the drop recipe creating system according to the third embodiment for the drop recipe manufacturer 300 creating the drop recipe. The same components as those in the first embodiment are denoted with the same numerals and a detailed explanation thereof will be omitted.

As illustrated, the drop recipe creating system 7 is configured such that the data storage server 3 is connected to a controller 8 via a network. The controller 8 may serve as the data storage server 3.

The data storage server 3 stores therein various items of data used in the drop recipe creating system 7. Specifically, the data storage server 3 stores therein the pattern data D31, the relievable area information D32 and the redundant area information D33 transmitted from the semiconductor integrated circuit manufacturer 100. The data storage server 3 stores therein the defect image data D34 and the defect position data D35 transmitted from the template manufacturer 200. The data storage server stores therein the relief area information D36 and the drop recipe D37 created by the controller 8.

The controller 8 generates the drop recipe D37 based on the pattern data D31 and the like stored in the data storage server 3, and outputs the generated drop recipe D37 to the data storage server 3.

The controller 8 is configured similar to a typical computer to have the CPU (Central Processing Unit) 51, the RAM (Random Access Memory) 52, the network interface 53, the ROM (Read Only Memory) 54, the CD-ROM drive 55, the input device 56 and the output device 57. The ROM 53 stores therein a drop recipe creating program 81 as computer program for creating the drop recipe D37, and the drop recipe creating program 81 is read by the CPU 51 and is loaded into the RAM 52.

The drop recipe creating program 81 executed by the controller 8 may be stored on a computer connected to a network such as Internet and downloaded via the network to be provided or distributed. The drop recipe creating program 81 may be provided or distributed via the network such as Internet. The drop recipe creating program 81 may be previously incorporated in the ROM 54 or the like to be provided to the controller 8. The drop recipe creating program 81 may be recorded in a recording medium such as the CD-ROM 59 to be provided or distributed. The drop recipe creating program 81 recorded in the CD-ROM 59 is read by the CPU 51 via the CD-ROM drive 55 and is developed in the RAM 52.

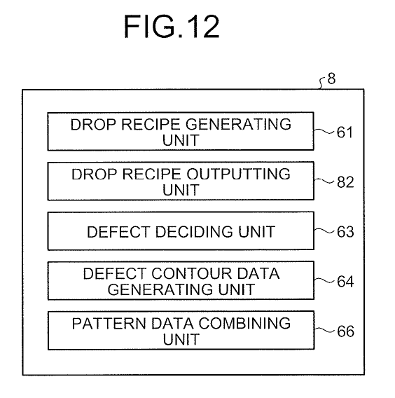

FIG. 12 is a diagram for explaining a functional structure of the controller 8 which is formed in the RAM 52 by the controller 8 executing the drop recipe creating program 81. As illustrated, the controller 8 includes the drop recipe generating unit 61, a drop recipe outputting unit 82, the defect deciding unit 63, the defect contour data generating unit 64 and the pattern data combining unit 66.

The drop recipe generating unit 61 generates the drop recipe based on the pattern data D31. The drop recipe outputting unit 82 stores the drop recipe D37 created by the drop recipe generating unit 61 in the data storage server 3.

The defect deciding unit 63 detects a defect with reference to the defect position data D35 and decides whether the detected detect is relievable. When deciding that the detected defect is relievable, the defect deciding unit 63 outputs the relief area information D36 indicating that the defect-occurred position is set as relief area.

The defect contour data generating unit 64 extracts the contour of the defect decided as relievable from the defect image data D34, and generates the defect contour data describing the defect contour shape. The pattern data combining unit 66 combines the defect contour data and the pattern data D31 and creates the pattern data for creating the drop recipe D37.

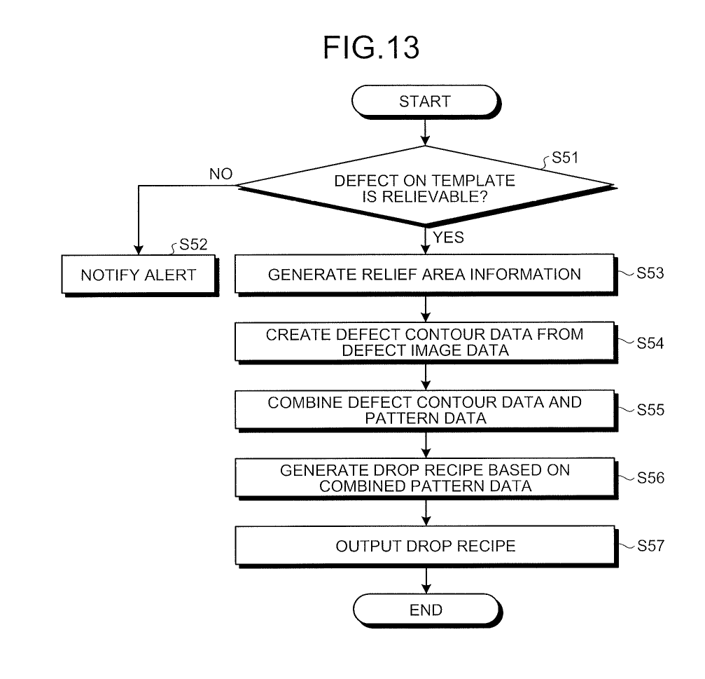

FIG. 13 is a flowchart for explaining the drop recipe creating method according to the third embodiment of the present invention. It is assumed herein that the data storage server 3 previously stores therein the pattern data D31, the relievable area information D32 and the redundant area information D33 transmitted from the semiconductor integrated circuit manufacturer 100 as well as the defect image data D34 and the defect position data D35 transmitted from the template manufacturer 200.

As illustrated, the defect deciding unit 63 first refers to the defect position data D35, the relievable area information D32 and the redundant area information D33 stored in the data storage server 3 to decide whether the defect occurring on the new template is relievable (step S51). The deciding method in step S51 is the same as step S6 in the first embodiment.

When the defect is not relievable (step S51, No), the defect deciding unit 63 outputs an alert on the display screen of the output device 57 (step S52). When confirming the alert, the drop recipe manufacturer 300 may send a notification for recommending the remanufacture of the templates for the semiconductor integrated circuit manufacturer 100 and/or the template manufacturer 200.

When the occurred defect is relievable (step S51, Yes), the defect deciding unit 63 generates the relief area information D36 for setting the relievable area including the defect-occurred position as relief area (step S53).

Subsequently, the defect contour data generating unit 64 creates the defect contour data from the defect image data D34 previously stored in the data storage server 3 (step S54). The pattern data combining unit 66 combines the created defect contour data and the pattern data D31 (step S55). The drop recipe generating unit 61 creates the drop recipe based on the combined pattern data (step S56). The drop recipe outputting unit 82 outputs the generated drop recipe D37 to the data storage server 3 (step S57) and then the drop recipe creating processing ends. The drop recipe manufacturer 300 sends the drop recipe D37 stored in the data storage server 3 to the semiconductor integrated circuit manufacturer 100.

In this way, according to the third embodiment, since there is configured such that the defect contour (defect contour data) is extracted from the previously-prepared defect image data D34 of the defect of the template (step S54), the extracted defect contour data is reflected on the previously-prepared pattern data D31 of the semiconductor integrated circuit (step S55), and the drop recipe is created based on the pattern data D31 on which the defect contour is reflected (step S56), the positional variation in residual layer thickness in the die immediately after the start of the transferring can be reduced when the imprinting is started by use of the new template.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An imprinting method for sequentially applying a hardening resin material on substrates to be processed based on a drop recipe defining an application amount distribution of the hardening resin material, and sequentially transferring a pattern of a semiconductor integrated circuit created on a template onto the substrates to be processed on which the hardening resin material is applied, the method comprising:
making a defect inspection on the pattern transferred on the substrates to be processed, thereby generating defect image data;
extracting a defect contour from the generated image data, reflecting the extracted defect contour on pattern data of the semiconductor integrated circuit, and performing a first drop recipe generating processing of generating a first drop recipe based on the pattern data on which the defect contour is reflected; and
updating the drop recipe used for applying the hardening rein material with the generated first drop recipe.

2. The imprinting method according to claim 1, wherein updating the drop recipe comprises:
calculating residual layer thicknesses of the pattern transferred onto the substrates to be processed based on the used drop recipe and the first drop recipe, respectively;
deciding whether a difference between the two calculated residual layer thicknesses is within a permissible range; and
updating the drop recipe when the difference is within the permissible range.

3. The imprinting method according to claim 1, further comprising:
extracting a defect contour from the generated image data, modifying the extracted defect contour into a rectangular shape including the defect contour or a rectangles-combined shape, reflecting the modified defect contour on pattern data of the semiconductor integrated circuit, and performing a second drop recipe generating processing of generating a second drop recipe based on the pattern data on which the modified defect contour is reflected,
wherein updating the drop recipe comprises:
calculating residual layer thicknesses of the pattern transferred onto the substrates to be processed based on the used drop recipe, the first drop recipe and the second drop recipe, respectively;
deciding whether both a difference between the residual layer thickness of the used drop recipe and the residual layer thickness of the first drop recipe and a difference between the residual layer thickness of the used drop recipe and the residual layer thickness of the second drop recipe are within a permissible range; and
updating the used drop recipe when both the differences are within the permissible range.

4. The imprinting method according to claim 1, wherein generating the image data comprises:
deciding whether a detected defect is relievable, and when the detected defect is relievable, generating the image data.

5. The imprinting method according to claim 2, wherein generating the image data comprises:
deciding whether a detected defect is relievable, and when the detected defect is relievable, generating the image data.

6. The imprinting method according to claim 3, wherein generating the image data comprises:
deciding whether a detected defect is relievable, and when the detected defect is relievable, generating the image data.

7. An imprinting method for sequentially applying a hardening resin material on substrates to be processed based on a drop recipe defining an application amount distribution of the hardening resin material, and sequentially transferring a pattern of a semiconductor integrated circuit created on a template onto the substrates to be processed on which the hardening resin material is applied, the method comprising:
extracting a defect contour from previously-prepared image data of a defect of the template;
reflecting the extracted defect contour on pattern data of the semiconductor integrated circuit;
generating a drop recipe based on the pattern data on which the defect contour is reflected; and
setting the generated drop recipe as a drop recipe used for applying the hardening resin material.

8. The imprinting method according to claim 7, comprising:
deciding whether the defect on the template is relievable; and
extracting a defect contour from the image data when the defect on the template is relievable.

9. A semiconductor integrated circuit manufacturing method for sequentially applying a hardening resin material on substrates to be processed based on a drop recipe defining an application amount distribution of the hardening rein material, and sequentially transferring a pattern of a semiconductor integrated circuit created on a template onto the substrates to be processed on which the hardening resin material is applied, the method comprising:
making a defect inspection on the pattern transferred on the substrates to be processed, thereby generating defect image data;
extracting a defect contour from the generated image data, reflecting the extracted defect contour on pattern data of the semiconductor integrated circuit and performing a first drop recipe generating processing of generating a first drop recipe based on the pattern data on which the defect contour is reflected; and
updating the drop recipe used for applying the hardening resin material with the generated first drop recipe.

10. The semiconductor integrated circuit manufacturing method according to claim 9, wherein updating the drop recipe comprises:
calculating residual layer thicknesses of the pattern transferred onto the substrates to be processed based on the used drop recipe and the first drop recipe, respectively;
deciding whether a difference between the two calculated residual layer thicknesses is within a permissible range; and
updating the drop recipe when the difference is within the permissible range.

11. The semiconductor integrated circuit manufacturing method according to claim 9, further comprising:
extracting a defect contour from the generated image data, modifying the extracted defect contour into a rectangular shape including the defect contour or a rectangles-combined shape, reflecting the modified defect contour on pattern data of the semiconductor integrated circuit, and performing a second drop recipe generating processing of generating a second drop recipe based on the pattern data on which the modified defect contour is reflected,
wherein updating the drop recipe comprises:
calculating residual layer thicknesses of the pattern transferred onto the substrates to be processed based on the used drop recipe, the first drop recipe and the second drop recipe;
deciding whether both a difference between the residual layer thickness of the used drop recipe and the residual layer thickness of the first drop recipe and a difference between the residual layer thickness of the used drop recipe and the residual layer thickness of the second drop recipe are within a permissible range; and
updating the used drop recipe when both the differences are within the permissible range.

12. The semiconductor integrated circuit manufacturing method according to claim 9, wherein generating the image data comprises:
deciding whether a detected defect is relievable, and when the detected defect is relievable, generating the image data.

13. The semiconductor integrated circuit manufacturing method according to claim 10, wherein generating the image data comprises:
deciding whether a detected defect is relievable, and when the detected defect is relievable, generating the image data.

14. The semiconductor integrated circuit manufacturing method according to claim 11, wherein generating the image data comprises:
deciding whether a detected defect is relievable, and when the detected defect is relievable, generating the image data.

15. A semiconductor integrated circuit manufacturing method for sequentially applying a hardening resin material on substrates to be processed based on a drop recipe defining an application amount distribution of the hardening resin material, and sequentially transferring a pattern of a semiconductor integrated circuit created on a template onto the substrates to be processed on which the hardening resin material is applied, thereby manufacturing the semiconductor integrated circuit, the method comprising:
extracting a defect contour from previously-prepared image data of a defect of the template;
reflecting the extracted defect contour on pattern data of the semiconductor integrated circuit;
generating a drop recipe based on the pattern data on which the defect contour is reflected; and
setting the generated drop recipe as a drop recipe used for applying the hardening resin material.

16. The semiconductor integrated circuit manufacturing method according to claim 15, comprising:
deciding whether the defect on the template is relievable; and
extracting a defect contour from the image data when the defect on the template is relievable.

17. A drop recipe creating method for extracting a defect contour from previously-prepared image data of a defect of a template, reflecting the extracted defect contour on previously-prepared pattern data of the semiconductor integrated circuit, and creating a drop recipe defining an application amount distribution of a hardening resin material based on the pattern data on which the defect contour is reflected.
